(19) United States
(12) Patent Application Publication
(10) Pub. No.: US 2007/0138076 A1
(43) Pub. Date: Jun. 21, 2007

(54) Devices and methods for microfluidic chromatography

(75) Inventors: Antoine Daridon, Mont-sur-Rolle (CH); Jiang Huang, San Jose, CA (US); Oai Phi, Belmont, CA (US); Andy May, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fluidigm Corporation, South San Francisco, CA (US)

(21) Appl. No.: 11/305,833

(22) Filed: Dec. 16, 2005

(51) Int. Cl. B01D 15/08

(52) U.S. Cl. 210/198.2; 210/490; 73/61.53; 422/70

(57) ABSTRACT

Embodiments of the invention provide devices, methods and systems for performing microfluidic chromatography. Particular embodiments provide microfluidic chromatography column devices which can perform chemical separation using small sample volumes and low pressure differentials across the column. One embodiment provides a microfluidic chromatography column device comprising a first, second and third capillary tube. A chromatographic packing is disposed in the second tube with a first and second support layer disposed on opposite ends of the second tube. The support layers are disposed in a substantially flat orientation within the tube. An external coupling joins the tubes such that the tubes are fluidically sealed. The device is configured to have a fluidic resistance such that a pressure differential across the column of less than about 10 psi produces a flow rate through the device of at least about 0.5 ml/min for a liquid solution.

### FIELD OF THE INVENTION

Embodiments of the invention relate to devices for performing microfluidic chromatography. More specifically, embodiments of the invention relate to microfluidic devices for performing liquid chromatography using a low pressure drop column.

### BACKGROUND OF THE INVENTION

Chemical and biological separations are routinely performed in industrial and academic settings to determine the presence and/or quantity of individual species in complex sample mixtures. One separation technique, liquid chromatography, encompasses a number of methods that are used for separating chemical components in a sample mixture.

Microfluidic systems and devices allow manipulation of extremely small volumes of liquids, and therefore, are particularly useful in small scale sample preparations, chemical synthesis, sample assay, sample screening, and other applications where a micro-scale amount of samples are involved. For many applications, such as high through-put drug screening, drug discovery, etc., the chemical make-up of the resulting material (i.e., sample) needs to be analyzed. Such analysis typically requires at least some amount of sample purification and/or separation. However, conventional chromatography devices or methods (e.g., high pressure liquid chromatography) are not suitable due to the small sample size (e.g., nanoliter to microliter) required by microfluidic devices.

Use of capillary liquid chromatography separation techniques (such as packed capillary chromatography) have become increasingly popular due to the ability of achieving high chromatography efficiency with operational pressures lower than those required for high pressure liquid chromatography (HPLC). While capillary chromatography requires less pressure than required by HPLC (typically >2000 psi) current capillary chromatography devices still require relatively high pressures (e.g., greater than 10 psi) and/or cannot achieve flow rates desirable for timely separation and rapid sampling time. Therefore, improved methods are needed.

### BRIEF SUMMARY OF THE INVENTION

Embodiments of the invention provide devices, methods and systems for performing microfluidic chromatography. Particular embodiments provide microfluidic column devices (also referred to herein as “column devices”) which can perform chemical separation using relatively small sample volumes and low driving pressures (e.g., 10 psi or less). These embodiments can achieve flow rates through the column of 0.5 ml/min or greater to allow for rapid separation of analytes and have relatively small dead volumes to minimize samples volumes and contamination between samples.

An exemplary embodiment provides a column device for microfluidic chromatography comprising first, second and third capillary tubes. A chromatographic packing is disposed in the second tube with a first and second support layer disposed on opposite ends of the second tube. Desirably, the support layers (also referred to as “supports” or “frits”) are disposed in a substantially flat orientation within the column device. An external coupling joins the tubes such that the tubes are fluidically sealed. The dimensions and packing of the column device can be configured such that the joined tubes hold a fluid volume of between about 0.5 to 10 μl, e.g., 0.5 to 5 μl.

The column device is desirably configured to have a fluidic resistance such that a pressure differential across the column (i.e. approximately between the ends of the column) of less than about 10 psi produces a flow rate through the device of at least about 0.5 ml/min for a liquid solution. This flow rate can be achieved when the device is in a vertical or horizontal orientation. The residual volume downstream from the packing is desirably less than 500 nl, and usually less than 100 nl. Residual volume is the volume of sample solution retained in a portion of device after the solution has been injected into the device. Low residual volumes facilitate the elution of the captured analyte into a very small volume of desorption solution (i.e., the elutent solution), allowing for the preparation of low volume samples containing relatively high concentrations of analyte. Low residual volumes are desirable when the analyte is used in a chemical reactor requiring a minimum volume of analyte, e.g. a reaction to produce a radioactive fluoride compound. Smaller residual volumes also minimize dilution of the analyte, allowing for narrower sampling peaks when the sample is analyzed using any number of detection methods. Desirably, the residual volume of the column device is such that analyte can be eluted off of the packing using less than 20 μl of elutent, and often less than 10 μl of elutent, such as between 5 and 10 μl of elutent. Also, the column can be configured to allow liquid volumes of 10 ml or greater to be rapidly flowed through and separated by the column.

Materials suitable for the capillary tubes includes polymers such as PTFE (polytetrafluoroethylene), silastic or PEEK (polyetheretherketone). The external coupling will typically comprise a heat shrink tubing, such as PTFE. The heat shrink tubing can be placed as an outer tube over an assembly comprising the capillary tubes and supports and then heated to shrink the tubing onto the first, second and third tubes. The heat shrink tubing couples the tubes together via a compressive radial force which also serves to hold the supports in place. Various components of the column device can also be selected to allow operation in high temperature environments such as 100° C. or greater. For example, various thermally resistant polymers can be used, such as polyetherimide, polysulfones, PTFE and related polymers.

The chromatographic packing can comprise any suitable chromatography material, including particles such as alumina or silica particles, porous silica particles and coated particles such as coated silica particles having a chemical coated or covalently bound stationary phase. Suitable stationary phases include ion exchange functional groups (e.g., anion exchange groups such as quaternary amines and cation exchange groups such as carboxylic acids) and various ligands (e.g., C18, C-4 C-8). In certain embodiments, the stationary phase may include immunological (e.g., antibody) groups that specifically bind an analyte, such as a peptide, polypeptide or protein. In a particular embodiment, the packing can include a cationic coating which binds fluoride compounds. In another embodiment, the packing can be an aluminum oxide configured to bind an acid or base as to provide acid/base neutralization of an injected sample. Desirably, the diameter of the packing material particles is greater than the pore size of the support material. The packing material can be configured to separate a first compound from a second compound. The first compound can comprise a small molecule, biomolecule or a reactant. The second compound will typically comprise a solvent in which the first compound is dissolved or suspended. The solutions/solvents that can be used in the column can include aqueous solutions, polar solvents (e.g., DMF), organic solvents (e.g., an acetonitrile solution). In one embodiment, the solution includes a carbonate solution for eluting an adsorbed fluoride compound.

The column device of the invention has a wide variety of uses which will be apparent to the skilled artisan. The column device is particularly useful for separation and/or purification of small molecules (e.g. molecular weight <500 Daltons), bio-molecules (e.g., hormones, polypeptides, polynucleotides, sugars); inorganic molecules or ions (e.g., flouride, chloride). In one embodiment, the column is used for purification and/or concentration of a radio-isotope (e.g., ¹⁸F). The column device can be integrated into microfluidic chips used for chemical synthesis (e.g., production of radiolabeled compounds such as ¹⁸[F]-fluoride compounds used in PET scans and other nuclear medicine applications). The column device also can be integrated into microfluidic chips for performing DNA analysis for genetic testing and DNA sequencing; protein analysis for proteomics and gene expression analysis; other chemical analysis for drug and other bimolecular assays, and other uses.

The column device can be configured to be integrated or otherwise coupled to a microfluidic system, such as a microfluidic chip. Typically the column device is coupled to one or more fluidic channels of the microfluidic device. These channels provide inflow and outflow to and from the column device and can be coupled to chemical reaction devices (e.g. a chemical reaction circuit), fluidic delivery devices (e.g., pumps), valves, pressure sources, reaction chambers, reservoirs and sensing devices (e.g., an optical sensor). The column device can also be coupled directly to a pump, valve, or pressure source wherein the tube ends of the column are coupled to these devices using e.g. push fitting, adhesive bonding or other joining method known in the art. The channels can be integral or otherwise built into the chip during chip fabrication or alternatively can be configured to be interchangeable such that one column device can be readily exchanged with another. The shape of the device can be configured to fit on or into a space on the chip such as a well or recess on the chip surface. The column device can be built into the chip or otherwise can be coupled to the chip using microfabrication techniques described herein or known in the art.

The microfluidic chip can be configured to perform one or more functions which utilize an elutent or other outflow from the column device. For example, the chip can be configured to utilize an eluted solution from the column device in a chemical reaction to produce a desired chemical compound. Also, the column device can be used to perform a chromatographic separation to rapidly produce a concentrated solution of a selected chemical reactant without having to perform an external processing step. This in turn speeds up the processing time on the chip, allowing for high throughput production of the desired chemical products. Accordingly in these and related embodiments, the inflow to the column device can be coupled to a source of dilute solution and the outflow to the chemical reaction chamber. In one embodiment of a microfluidic chip having an integrated column device, the column device can be integrated into the chip so as to rapidly concentrate a radioactive fluorine solution (e.g., from a concentration of 1 ppm to over 100 ppm). This solution is then used in a chemical concentration loop coupled to the column to produce a radio-pharmaceutical such as ¹⁸F-flouro-D-glucose (see description below).

Embodiments of the column device can also be coupled directly or indirectly to analytical instruments such as, for example, a mass spectrometer, a tandem mass spectrometer or gas chromatograph mass spectrometer. This allows the elutent to be fed into the instrument for further separation and analysis in either the liquid or a gaseous state. The coupling to these instruments can be though capillary or other tubing or via a spray coupling such an electrostatic spray coupling. In alternative embodiments, the device can be configured to engage an external fluid delivery device such device such as a pipettor, syringe, or external pump.

In an exemplary embodiment of a method for using a microfluidic column device of the invention, where the device is integrated into to a microfluidic chip, a sample volume of solution containing one or more compounds to be separated is injected into the column device via a fluidic channel or other fluid conduction means. The low fluidic resistance of the column allows the solution to flow through the column at rates of 0.5 ml/min or faster using a pressure differential across the column of less than 10 psi. The pressure differential can be generated using a micro-pump or other pressure source. As the sample volume moves through the packing, the compound can interact with the packing in a variety of ways. For example, interaction can occur via hydrophilic, or ionic interactions or chemical adsorption. In the latter case, a desorption solution is injected into the column after the sample volume has flowed through and the compound of interest adsorbed to the stationary phase. This can be achieved using only 5 to 10 μl of solution. Both the sample volume and desorption solutions can be passed rapidly though the column at flow rates of 0.5 ml/min and at pressures of less than 10 psi. For example, a 10 ml volume of solution can pass through the column in 20 minutes or less, a 1 ml volume of solution can pass through in 2 minutes or less and a 5 μl volume can pass through in 6 seconds or less. One or both of the inflow and the outflow from the column can be electronically controlled or otherwise automated, for example, through use of control valves or metering pumps that are coupled to a microprocessor. The inflow or outflow can be synchronized or otherwise temporally linked to another event or process, such as an endpoint in a chemical process or a achievement of a temperature, pressure or flow rate, or rate of change thereof in another portion of the chip. The method can be used to rapidly separate compounds such as proteins, polypeptides, nucleotides, fluorides, halides or other selected compounds. These and other embodiments and aspects of the invention are described in further detail below.

### BRIEF DESCRIPTION OF THE DRAWINGS

FIG. 1 is a schematic view illustrating operation of chromatographic column.

FIG. 2A is a lateral view illustrating an embodiment of a microfluidic chromatography device.

FIG. 2B is a cut-away view illustrating the components of an embodiment of the microfluidic chromatography device.

FIG. 3 is a schematic view illustrating an embodiment of a microfluidic chromatography device incorporated into a microfluidic system such as a microfluidic chip.

FIG. 4A is a perspective view of a bottom portion of a microfluidic chip including a recess for holding a microfluidic chromatography device.

FIG. 4B is a lateral view illustrating a recess in a microfluidic chip for holding the microfluidic chromatography device.

FIGS. 5A-5E are cross sectional views illustrating dimensions of various components of an embodiment of the microfluidic chromatography device. FIG. 5a shows the connecting tubes, FIG. 5b shows the packing section, FIG. 5c shows the coupling, FIG. 5d shows the membrane and FIG. 5e the packing.

FIG. 6 is a schematic view illustrating a plurality of columns arranged in series or parallel configuration.

FIG. 7 is a schematic view illustrating an embodiment of the microfluidic column coupled to a chemical reaction device.

FIGS. 8A-8C are schematic views illustrating use of the microfluidic column with the chemical reaction device.

FIG. 9 is a schematic view illustrating use of the column with a detector and/or analytical instrument.

### DETAILED DESCRIPTION OF THE INVENTION

I) Definitions

The following definitions are provided to aid in understanding the invention. Unless otherwise defined, all terms of art, notations and other scientific or engineering terms or terminology used herein are intended to have the meanings commonly understood by those of skill. In some cases, terms with commonly understood meanings are defined herein for clarity and/or for ready reference, and the inclusion of such definitions herein should not be assumed to represent a substantial difference over what is generally understood in the art.

As used herein, the term “analyte” refers to a chemical entity (e.g. an element or compound) that is present in a test sample (e.g., a solution).

As used herein, the terms “binding” and “bound” and grammatical equivalents of these terms, refer to a non-covalent or a covalent interaction, that holds two molecules together. Non-covalent interactions include hydrogen bonding, ionic interactions among charged groups, van der Waals interactions and hydrophobic interactions among nonpolar groups.

As used herein, the terms “capillary” or “capillary tube” refer to a tube having an internal diameter of less than 1 mm, sometimes less than 0.5 mm, and sometimes less than 0.25 mm.

As used herein, the terms “channel”, “flow channel,” “fluid channel” and “fluidic channel” are used interchangeably and refer to a pathway on a microfluidic device in which a fluid can flow.

As used herein, the terms “chromatography column”, “column device” and “column” are used interchangeably herein and refer to a device that is capable of separating at least a portion of a compound in a sample from other components in the sample.

As used herein, the term “fluidically coupled” means that a fluid can flow between two components that are so coupled.

As used herein, the term “joined capillary tube” refers to two or more capillary tubes that have been mechanically joined so that a liquid injected into the lumen of one capillary tube would flow into the lumen of an adjacent capillary tube. It will be appreciated that the liquid flowing through the lumens could also flow through packing material, frits, and the like.

As used herein, the term “microfluidic” refers to a system, device or element for handling, processing, ejecting and/or analyzing a fluid sample including at least one channel having microscale dimensions ( e.g., a cross sectional dimension such as width, depth or diameter of less than about 0.5 mm and sometimes less than 0.25 mm).

As used herein, the term “microfluidic function” refers to any operation, function or process performed or expressed on a fluid or sample in a microfluidic system, including, but not limited to: filtration, pumping, fluid flow regulation, controlling fluid flow and the like.

As used herein, the term “porosity” when referring to a membrane or packing refers to the fraction of total volume of the membrane volume or packing volume that is porous.

As used herein, the term “pressure differential” or “driving pressure” refers to the pressure differential across the length of the column which causes flow through the column.

As used herein, the term “port” refers to a structure for providing fluid communication between two elements using e.g., a fluidic channel.

As used herein, the term “separation” or “chromatographic separation”, unless otherwise indicated, refers to the ability of the column to separate two or more chemical entities (e.g., elements or compounds) injected into the column based on differences in the interactions of the chemicals with the column packing.

As used herein, the term “monolithic valve” refers to a configuration in which two channels are separated by an elastomeric segment that can be deflected into or retracted from one of the channels in response to an actuation force applied to the other channel.

II) Chromatographic Separation Methods

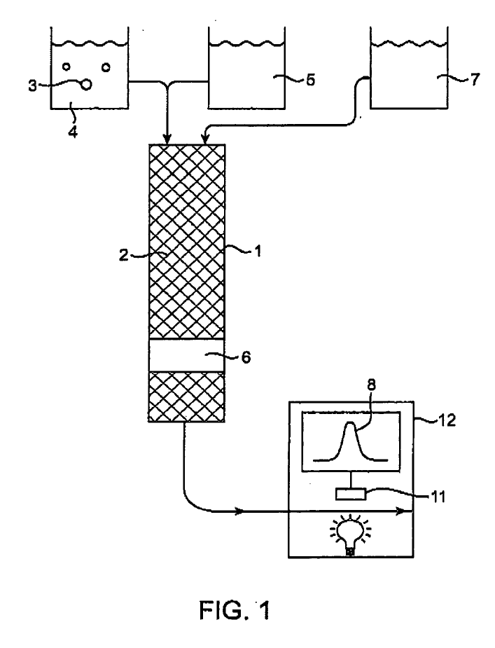

As an initial matter, a discussion will be presented to provide a background on chromatographic separation methods and microfluidic systems and devices. Referring now to FIG. 1, chromatographic separation methods typically involve use of a chromatographic column 1 containing a stationary phase 2 which is used to separate an analyte 3 in a sample solution 4 (also called analyte mixture 4). The stationary phase is selected to interact with a selected analyte (e.g. by adsorption, hydrophobic interactions, etc). In some approaches, the stationary phases is bound (e.g., covalently bound) to a particle such as silica particles. Alternatively, the stationary phase can be bound directly to the column.

In some approaches, the analyte mixture can be added to a mobile phase 5 (e.g. a liquid or gas) which is then injected into the column so that the mobile phase is passed through the stationary phase. As analyte molecules flow through the column in the mobile phase, they can interact with the stationary phase (e.g., by adsorbing and desorbing from the stationary phase, or entering and exiting pores within the stationary phases). This results in the analyte molecules having a longer residence time in the column than in the pure mobile phase. The longer residence time in the stationary phase causes the analyte molecules to fall behind the pure mobile phase. Identical molecules migrate at approximately the same rate. Thus, conditions are chosen such that differing molecules migrate at different rates. If differing molecules pass through the system at sufficiently different rates, a separation is achieved.

In some approaches, during the chromatographic process the analyte forms move in bands or zones 6 of concentrated solution within the mobile phase or elutent solution (see below). When the zones of solution exit the column they can be detected by a detector 11 such as an IR detector and measured by an analytical instrument 12 (e.g. a spectrophotometer). In other approaches, the analyte passes directly through the column while other compounds in the sample are retained by the column and thereby separated from the analyte. In still other approaches, the analyte is bound to the stationary phase and eluted by addition of a solution that disrupts the binding of the analyte and/or displaces the analyte from the stationary phase. Still other chromatography approaches are known in the art.

The efficiency of a chromatographic separation can depend on many factors including selection of the stationary phase, polarity of the mobile phase, size of the column (e.g., length and diameter) relative to the amount of material to be chromatographed, and the rate of elution. Longer columns typically result in greater amounts of separation and better resolution of separated components. The columns can be a single pass separation (i.e., separation is achieved by passing only one solutions through the column) or a multiple pass separation (separation is achieved by passing multiple solutions two or more solutions through the column). An example of a single pass separation can include the use of organic analytes and a packing material comprising silica particles that have been derivatized to have a stationary material comprising a ligand (e.g., an alky C4, C8 or C18 alky chain or an antibody or a protein). The ligand on the particles interacts with the analytes as they pass through column such that analytes that are more similar (e.g. more hydrophobic, polar, etc) to the bound ligands will progress more slowly through the stationary phase, thereby effecting a separation.

In cases of multiple pass separation, the analyte can bind tightly to the stationary phase so as to require a different solution to elute the analyte from the packing. This solution is known as the elutent solution 7. For example, proteins and peptides over 5 amino acids in length are too large to partition through the stationary phase. Instead, when dissolved in an aqueous mobile phase, these large molecules adsorb tightly to the stationary phase. They will not be released (desorbed) until an organic elutent solution is injected into the column. Typical organic elutents used to desorb proteins and peptide can include acetonitrile, alcohol (e.g., methanol, ethanol, or isopropanol) and other relatively polar organic solvents (e.g., DMF), salt solutions, or mixtures thereof.

III) Microfluidic Devices.

The microfluidic column device of the invention can be used in conjunction with a variety of systems, including a variety of microfluidic systems (e.g., chips). For illustration, suitable microfluidic systems for use in conjunction with the microfluidic column device of the invention can be made from any of a variety of materials (e.g., silicon, glass, metal, plastics, and elastomers) using any of a variety of techniques (e.g., soft lithography; wet etching, reactive ion etching, micromachining, photolithography, replica molding, hot embossing, injection molding, laser ablation, in situ construction, plasma etching and the like. Methods of making and using a variety of microfluidic devices are known in the art and are described in, for example, Fiorini and Chiu, 2005, “Disposable microfluidic devices: fabrication, function, and application” Biotechniques 38:429-46; also see, Beebe et al., 2000, “Microfluidic tectonics: a comprehensive construction platform for microfluidic systems.” Proc. Natl. Acad. Sci. USA 97:13488-13493; Rossier et al., 2002, “Plasma etched polymer microelectrochemical systems” Lab Chip 2:145-150; Becker et al., 2002, “Polymer microfluidic devices” Talanta 56:267-287; and Becker et al., 2000, “Polymer microfabrication methods for microfluidic analytical applications” Electrophoresis 21:12-26.

The microfluidic devices disclosed herein may be constructed at least in part from elastomeric or like materials using single and/or multilayer soft lithography (MSL) techniques and/or sacrificial-layer encapsulation methods (see, e.g., Unger et al., 2000, Science 288:113-116, and PCT Publications WO 01/01025; WO/02/43615 and WO 01/01025 incorporated by reference herein for all purposes). Such methods can be used to fabricate a variety of microfluidic devices which have flow channels for the flow of fluid through the device and various features for controlling the fluid flow. In many embodiments, flow channels of the device can be controlled, at least in part, utilizing one or more control channels that are separated from the flow channel by an elastomeric membrane or segment. This membrane or segment can be deflected into or retracted from the flow channel with which a control channel is associated by applying an actuation force to the control channels. By controlling the degree to which the membrane is deflected into or retracted out from the flow channel, solution flow can be slowed or entirely blocked through the flow channel. Using combinations of control and flow channels of this type, one can prepare a variety of different types of valves and pumps for regulating solution flow as described in Unger et al., supra, and PCT Publications WO/02/43615 and WO 01/01025.

IV) Embodiments of the Microfluidic Chromatographic Device

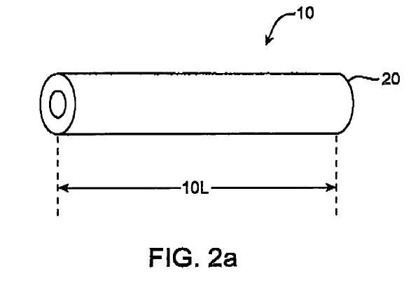

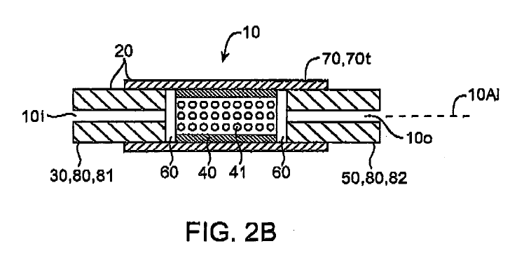

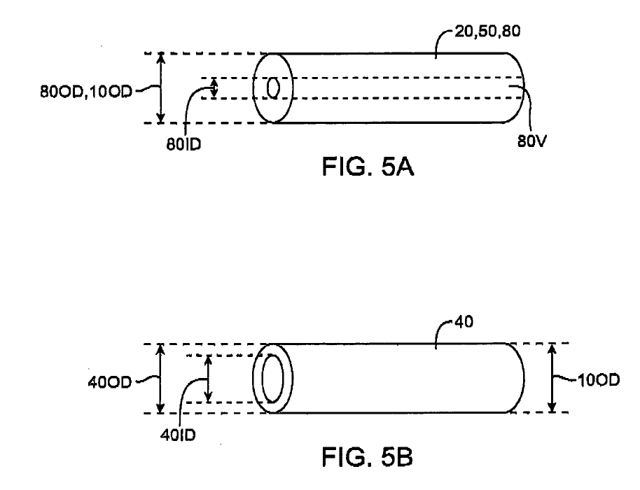

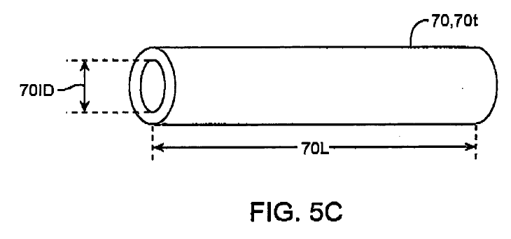

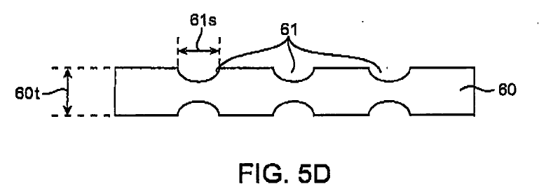

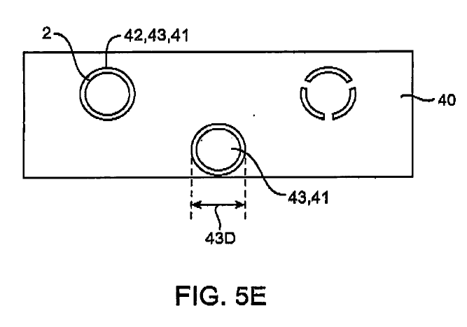

Referring now to FIGS. 2-5, various embodiments of a microfluidic chromatography device 10 (also described as column device 10) can comprise ajoined capillary tube 20 including a first capillary tube 30, second capillary tube 40 and a third capillary tube 50. For ease of discussion, capillary tubes 30, 40 and 50 will be referred to as tubes 30. Tube 40 is also sometimes referred to as a packing section 40. Packing section 40 includes a packing 41 which is supported or otherwise held in place by one or more support members 60 (also called support layers 60, supports 60, or frits 60). Typically, two support members 60 are used, but other numbers may also be used (see below). The parts are joined by a coupling 70 which is typically an external coupling, but an internal coupling may also be used (see below).

First and third tubes 30 and 50 function as access tubes 80 providing fluid inflow and outflow to and from packing section 50. Either tube can be configured as an inflow 81 or outflow tube 82 to packing section 40. The first and third tubes 30 and 50 can function as connection tubes 80 for coupling of column device 10 to one or more of channels, valves, pumps, detectors or other device on a microfluidic chip or other microfluidic system. In this and related embodiments, tubes 80 thus function as a fluidic inlet 10i and outlet 10o for column device 10. In particular embodiments, outlet 10o can be interconnected to a detector such as an IR or UV/VIS detector 11, or analytical instrument 12 for analyzing the solution existing the column. Alternatively, the outlet 10o can be interconnected to another microfluidic device which can further manipulate the existing solution, e.g., a chemical reaction chamber that utilizes a solute as a reactant in a chemical synthesis.

Various embodiments of column device 10 can be configured to allow for rapid chromatographic separation of a test sample using low pressure differentials. Specific embodiments are configured to achieve flow rates of 0.5 ml per minutes or lower of a test solution or elutent solution with a pressure differential of 10 psi or less or even 5 psi or less. For example, in one embodiment 1 ml of a test solution can be flowed through the column in two minutes or less using a pressure differential of 10 psi or less. The desired flow rate can be achieved by configuring the column device to have low amounts of fluidic resistance through the selection of one or more of the following parameters: i) support layer thickness; ii) pore size and porosity of the support layer; iii) length and inner diameter of the packing section; iv) particle size and porosity of the packing; v) length and inner diameter of the access tubes; vi) surface tension of the inner wall of the packing section tube; and vii) surface tension of the inner wall of the access tubes. In most embodiments, the column device is configured to perform separation of a sample volume of liquid, where the sample volume flows through the column in a single direction, but in alternative embodiments, the column device can be configured to have the sample volume flow through the column in two directions.

Fluidic resistance is generally defined as pressure drop divided by flow rate, and in this case is the pressure differential put across the ends of the column divided by the flow rate of a particular fluid flowing through the column for that pressure differential. Fluidic resistance, flow rates and pressures across the column can be measured using standard instruments and methods known in the art such as ASTM (American Society for Testing and Materials) methods. In one approach, the fluid resistance of the column for a selected fluid (e.g. an aqueous solution) can be measured by attaching a variable pressure pump generating a selected pressure to the inflow end of the column and then measuring the pressure and flow rate of fluid pumped through the column. Pressure can be measured using a standard pressure sensor or gauge known in the art. Flow can be measured volumetrically or using a flow gauge or sensor known in the art. Using this approach, the pressure can be set to, for example, 10 psi and the resulting flow rate measured. Alternatively, the pump can adjusted to achieve a flow rate of 0.5 ml/min and then the pressure to achieve this flow rate is measured.

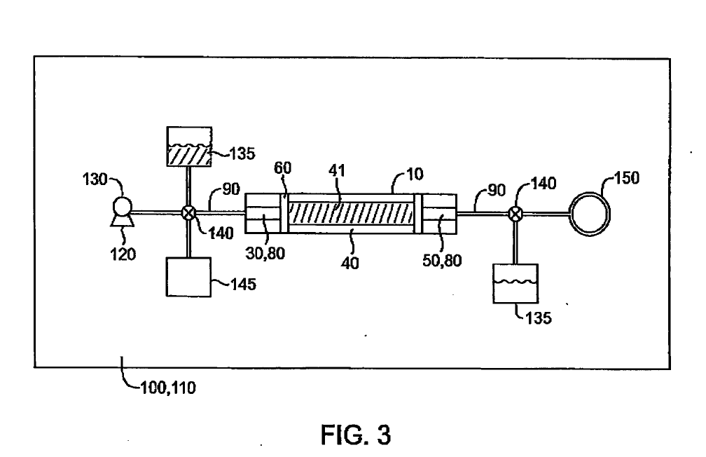

In some embodiments, column device 10 is integrated into a microfluidic system 100 such as a microfluidic chip 110 as shown in FIG. 3. In one embodiment, the column device can be mounted onto the chip e.g., via a recess 100r discussed herein. Column device is also desirably fluidically coupled to chip 110. By “fluidically coupled” it is meant that a fluid can flow between column device 10 and chip 100. Typically this can achieved by coupling one or both of tubes 30 and 50 to one or more fluid channels 90 as is shown in FIG. 3. Tubes 30 and 50 can also be coupled to one or more microfluidic devices or components 120 on the chip such as microfluidic pumps 130, reservoirs 135, valves 140, pressure sources 145 and chemical reaction devices 150. Valves 140 can include monolithic microfabricated valves such as those described by Unger et al. (see above). Tubes 30 and 50 can be joined to channels 90 or device 120 using push fitting, heat sealing, adhesive or various micro-fabrication techniques. Further description on the use of microfabrication techniques and components to integrate a microfluidic column to microfluidic chip is found in U.S. patent application Ser. No. 10/874103 (Publication No. 20050000900) and U.S. Pat. No. 6,752,922 which are fully incorporated by reference herein for all purposes. In alternative embodiments, access tubes 80 or other portion of column device 10 can be configured to be coupled to a port of an external pump, dispensing device, reservoir or analytical instrument (not shown).

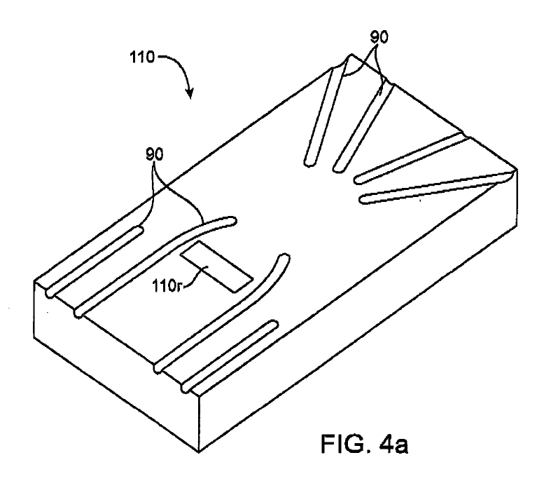

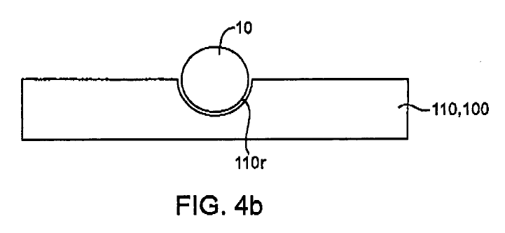

Column device 10 can have various dimensions and shapes which can be adapted to fit onto a selected microfluidic chip 100. The length 10L of the column can range from 1 to 10 mm and more preferably from 5-6 mm. Longer columns lengths can be used when greater amounts of chromatographic separation are desired. In various embodiments, the column can be shaped to fit horizontally into a recess or well 110r of chip 100 (See FIGS. 4A and 4B). In these and related embodiments, the column can have a cylindrical like shape or a hot dog like shape which can correspond to the shape of the recess. The column can be coupled to the chip or other microfluidic system using one or more of adhesive bonding, ultrasonic welding, snap fit or various micro-fabrication techniques described herein or known in the art. In a particular embodiment, the column is coupled to the chip using a laminated film such as an adhesive film.

In various embodiments, column 10 and/or section 40 can be configured to hold between 0.1 and 10 μl of a sample liquid and more preferably, between 0.2 and 5 μl of liquid and still more preferably, between 0.2 to 2 μl. Factors affecting the liquid capacity of the column include the column dimensions as well as the amount and particle size of the packing material and the tightness of the packing (e.g. whether packing is tightly loosely packed within the column). In particular embodiments the wetted volume of the column (the amounted of fluid the packed column holds) is approximately 40% of the empty volume. Thus a column which had a empty volume of 5 μl would have a wetted volume of 2 μl.

A discussion will now be presented of the various components of column device 10.

V) Capillar Tubes

Tubes 30, 40 and 50 can be fabricated from various resilient polymers known in the art such as silastic, PEEK and urethanes. In preferred embodiment, the sections are fabricated from PTFE (an example of which includes TEFLON, available from the Dupont Corporation).

In various embodiments, the components of column device 10 can be selected to be compatible with use with one or more solvents such as ethanol, methanol, methylene-chloride, DMF, acetonitrile as well as various acids such as hydrochloric acid. Suitable component materials in this regard include PTFE and other solvent resistant polymers known in the art. Also in various embodiments, the components of column device 10 can also be selected to allow for operation in high temperature environments such as 100 ° C. or greater. For example, various thermally resistant polymers can be used in the fabrication of tubes 30, 40 and 50 and coupling 70. Examples include polyetherimide (e.g., ULTEM, available from the General Electric Corporation), PTFE and other thermally resistant polymers known in the art.

Tubes 30, 40 and 50 can have various dimensions. The inner diameters of tube 30 and tube 50 may be the same or different. The inner diameter of tube 40 may be the same or different from the inner diameter of tube 30 and/or 50. Generally the inner diameters of tubes 30 and 50 (tube 80) are the same as or smaller than inner diameter of tube 40, but in some embodiments the inner diameter of tube 80 is larger. The ratio of the inner diameter 80ID of tubes 80 to the inner diameter 40ID of tube 40 can range from 1:1 to 1:10 with a preferred ratio of about 1:5. In one embodiment, tubes 80 can have an inner diameter of 100 μm and tube 40 has an inner diameter of 500 μm. The inner diameters of tubes 80 can be sized to achieve minimal residual volumes in those sections, while the inner diameter 40ID of tube 40 can be sized to hold a desired amount of packing material. In specific embodiments tubes 80 (e.g., tubes 30 and 50) can have an inner 80ID diameter ranging from about 50 to 500 μm, and more preferably about 100 to 200 μm. The inner diameter 40ID of tube 40 can range from about 200 to 750 μm with a preferred diameter of about 500 μm. The outer diameter 10OD of any of the tubes can range from about 0.5 to 1.5 mm with a specific embodiment of 1 mm. Generally (though not necessarily), the outer diameter of tubes 30, 40 and 50 will be the same, at least at the points at which the tubes are joined to each other. The outer diameter of all the tubes can be adapted to fit on or into a portion of a microfluidic chip 110 such as a well or recess discussed herein. Desirably, the length and internal diameter of access tubes 80 are configured such that the residual volume 80v is less than 100 nl and more preferably, less than 50 nl. Reduced residual volumes can be achieved by tapering all or a portion of tubes 80. Tapering can be achieved using polymer tube processing methods known in the art such as necking, molding and the like. Having an increased inner diameter for tube 40 can reduce its fluidic resistance and thus, increase flow rate the tube and the column device. Having a decreased diameter for tubes 30 and 50 reduces their residual volumes.

VI) Coupling

Coupling 70 is configured to mechanically join tubes 30, 40 and 50 such that tubes 40 and 30/50 are fluidically sealed. That is, fluid will not appreciably leak from the junction of the respective tubes at the operational pressures of the column, e.g., 10 psi or less. The coupling can comprise various mechanical fasteners and/or an adhesive materials known in the art. In many embodiments coupling 70 comprises an externally placed tube 70t fabricated from heat shrink tubing (e.g. heat shrink PTFE tubing) which joins the tubes through a compressive radial force exerted by tube 70t. Typically, tube 70t is advanced over tubes 30, 40 and 50 and then through the application of heat (e.g., from a heat gun, catheter thermal box, or other heating device), tubing 70t shrinks in diameter such that it exerts a compressive force around perimeters of tubes 30, 40 and 50 to join and fluidically seal the tubes together. Desirably, the compressive force is sufficient to not only join the respective sections of tubing, but also hold support members 60 in place between the tubes in a substantially flat orientation during operation of the column. The amount of shrinkage can be controlled by one or more of the material (e.g., the polymer composition, degree of cross linking, etc) and dimensions of tube 70t as well as the amount and duration of heat applied to the tube. A tubing material for tubing 70t can be selected which has a predetermined amount of shrinkage (e.g., 10-30%). The initial and final inner diameters of tubing can be selected depending upon the outer diameter of tubes 40 and 80 and the desired amount of compression of tubes 40 and 80. Desirably, tube 70t has an initial inner diameter 70ID such that it can be slid over tubes 40 and 80. Also, desirably the amount of shrinkage of tube 70t is such that its final or shrunk diameter is slightly smaller (e.g., up to about 10%) than the outer diameter 40 OD of tube 40. In alternative embodiments, coupling 70 can comprise an internal coupling such as a tube or mechanical fastener (not shown) placed within tubes, 30,40 and 50.

In various embodiments, the length 701 of tube 70t can be such that it extends over a portion of tubes 30 and 50, is flush with the ends of tubes 30 or 50 or even extends past those tubes. In the latter embodiment, only the section of tubing overlying tubes 30, 40 and 50 is heated. Mandrels can be inserted into ends of tube 70t during the heating step to maintain the patency of the section of tube 70t extending past tube 30 and 50.

VII) Support Member

Support member 60 serves to both the hold the packing in place in column 10 and allow fluid flow through the column. The support member can be selected for various properties to enhance flow through the column and minimize sample or elutent volume. Desirably, the support member has a low residual volume (that is, the volume of fluid held by the membrane when wetted) and a low fluidic resistance to flow of the various sample and processing liquids through the membrane. Also, the support member desirably has sufficient structural rigidity to hold the packing 41 in place during fluid flow through the column. Typically, two support members 60 are used and placed on either end of packing 41. In alternative embodiments, other numbers and configurations of the support member can be employed. For example, two support members can be placed on either end of the packing, or two can be placed at one end and only one at the other end. The number and positioning of the support members can be configured to produce a desired combination of fluidic and mechanical properties within the column. For example, two support members or even a thicker support member can be used at the inflow or high pressure end of the column and only one or a thinner member at the outflow end. In another embodiment, only one support member is used at the outflow end so as to reduce the fluidic resistance in the column. The particular configuration and number of support members can be selected to optimize flow though the column for selected packings, driving pressures and properties of the solution to be separated (e.g. viscosity, surface tension).

In many embodiments, the support member 60 is fabricated from a porous membrane such as a woven or non woven porous membrane. Accordingly, for ease of discussion, support member 60 will now be referred to as membrane 60 or frit 60. Suitable materials for membrane/frit 60 can include without limitation, PTFE, PET, cellulose and like materials. These materials can comprise a woven or non-woven meshes of fibers. Also the fibers may be a mesh weave, a spun bonded mesh, a random orientated mat of fibers or an etched or a pore drilled paper. Suitable commercially available membranes include without limitation ZYLON (5 μm pore size, available from Pall Life Sciences) and various cellulose membranes available from the Whatman PLC including part numbers 1001-042 (11 μm pore size), 1002-042 (8 μm pore size), and 1003-055 (6 μm pore size). Alternatively, the support member can be fabricated from porous metals such as porous titanium, porous plastics such as PEEK and also porous silicon.

In many embodiments, the membrane is sized to be positioned in the tubing 70 between tubes 40 and 30/50. The membrane will typically have a circular shape with a diameter 60D approximating the inner diameter of tube 70t. The membrane can be pre-sized or cut to size. Desirably, the membrane is positioned flush with the inner walls of tube 70t (or other coupling 70) and is maintained in a relatively flat orientation in the tubing (that is its surface is perpendicular to the longitudinal axis 10AL of the column). Alternatively, the surface of the membrane can have a concave, convex or other curved shape. The membrane can be held in place in a flat orientation within tube 70t by the radial compressive forces of the tube after it is shrunk. The ends of tubes 30/50 and/or 40 can also act as flanges to provide additional support to the membrane. Alternatively, the membrane can be coupled to tubing 30, 40 or 50 using an adhesive bond, solvent bonding or though Rf or ultrasonic welding or other bonding method know in the polymer arts.

Porous membrane 60 will typically have a plurality of pores 61 having a major dimension or size 61s. The pore size 61s and thickness 60t of membrane 60 can be selected to minimize the fluidic resistance of the membrane while at the same time keeping the chromatographic packing in the column. The pore size 61s of membrane 60 is desirably selected to be smaller than the particle size of packing 41 such that packing particles are not able pass through the membrane. For example, the pore size 61s of the membrane can range from 1 to 20 μm and more preferably 5 to 15μwith specific embodiments of 5, 6, 8, 11 and 12 μm. The thickness 60t of the membrane can range from 100 to 200 μm, with a specific embodiment of 150 μm. In various embodiments, the membrane can be selected to have flow rates of 1 to 10 ml/min for pressure differential of less than 10 psi.

VIII) Packing Material

Section 40 includes a chromatographic packing 41′ configured to perform a chromatographic separation of one or more compounds from a sample solution as described herein. The packing 41 can comprise a solid support 42 with a stationary phase 2 that is covalently bound or coated onto the solid support. The stationary phase can be selected to separate a particular compound from a solution, for example, an inorganic or inorganic compound, a polypeptide (e.g. a protein), a polynucleotide (e.g. DNA or RNA), a polysaccharide, a radionuclide, and the like. The stationary phase can also be selected to separate classes of compounds, e.g. polypeptides from polynucleotides. Suitable stationary phases include, ligands (e.g., C18, C-4, C-8), cDNA, proteins and antibodies. Solutions/solvents that can be used in the column (either as the sample solution or elutent solution) can include aqueous solutions, polar solvents (e.g., DMF) an organic solvents (e.g. an acetonitrile solution). In one embodiment, the solution comprises a carbonate solution for eluting an adsorbed fluoride compound.

In many embodiments, the packing comprises particles 43 (which act as the support 42) that are coated or covalently bound with stationary phase 2. For example, and without limiting the invention, two types of particle based packings are commonly used, silica particles and polymer particles. There are two distinct groups of silica-based packings which can be used. One group includes functionalized silica, where a functional group is chemically bonded (e.g., covalently bonded) directly to the silica particle. The second group is polymer-coated silica, in which the silica particles are first coated with a layer of polymer, such as polystyrene, silicone or fluorocarbon, and this layer is then functionalized to produce stationary phase 2. Also, the silica particles can include porous silica particles which allows mobile phase to flow in and out of the particles. This allows for more surface area for separation and thus greater amounts of separation for a particular column length.

Polymeric based packings are referred to as resins. Many resins are used to perform ion exchange type separations and thus include an ionic functional group. These resins are manufactured by first synthesizing a polymer with suitable physical and chemical properties, and then they are further reacted to introduce an ionic or other functional group. Typical polymer materials used to form the particles include copolymers of styrene and divinylbenzene (PS-DVB), and divinylbenzene and acrylic or methacrylic acid. Polymer/reside based ion exchange packing allow for separations to be done over range of pH including 0 to 14. This wide range of pH values enables the exploitation of selectivity effects of multi-charged or weakly ionizable solutes.

In various embodiments, the size of the packing particles (typically diameter) can be selected based on several factors including the particular compound to be separated and the desired flow rate through the column. In the case of polymer particles, the size of the particles is controlled during the polymerization step and then the particles are sieved to obtain a uniform range of particle size using standardized mesh ranges known in the art (e.g. 200-400, etc). Larger particles sizes can result in reduced fluidic resistance and thus increased flow through the column for a given pressure differential. Use of smaller particles can improve separation efficiency within the column. More uniform particles size distribution can also result in tighter separation peaks when the analyte exists the column. In various embodiments, the diameter 43D of the packing material particles can range between about 40 to 100 μm, and more preferably between 50 to 90 μm to with specific embodiments of 50, 60 and 80 μm. Preferably, the particles size is greater than the pore size of the support 61 as discussed herein. The particles size can also be selected to control the wetted volume of the column. Smaller size particles can result in greater wetted column volumes.

In particular embodiments, the packing can include ion exchange resins such as an anion exchange resin configured to bind a fluoride compound. One example of an anion exchange resin includes HEI X8 (screened with 200-400 mesh) available from the BioRad Corporation. In other embodiments, the packing can comprise an A1₂O₃ or other metal oxide packing configured for acid or base neutralization of sample solution.

In alternative embodiments, packing 41 can comprise a monolithic packing (not shown) in which the stationary phase comprises a substantially continuous interconnected skeleton with large through-pores. This structure reduces the diffusion path of fluid through the column and provides high permeability, resulting in excellent separation efficiency. The integral structure enhances the mechanical strength of the column, while the large through-pores have very low flow impedance.

Synthetic polymer monolithic columns can be fabricated by in situ polymerization of mixtures of monomers and pyrogens within fused-silica capillaries which have been functionalized for example with vinyl groups. The resulting monolithic polymer bed is a uniformly porous piece integrated with the quartz capillary wall. After polymerization, various ligands (e.g., C-4, C-8, C-18) or other stationary phases can be applied using techniques known in the art.

IX) Multicolumn Embodiments

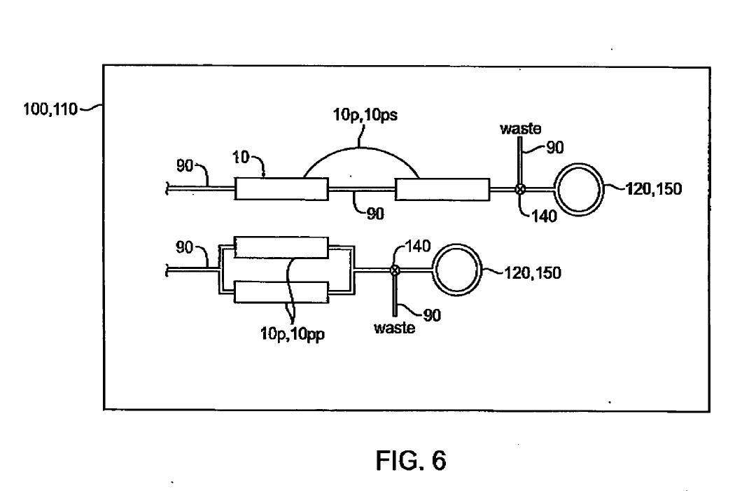

Referring now to FIG. 6, in various embodiments, a microfluidic chip 110 or other microfluidic system 100 can include a plurality 10p of microfluidic columns 10. Such a plurality of columns can be arranged in a series configuration 10ps to provide separation of a number of analytes within a single sample fluid. They can also be arranged in a parallel configuration 10pp to provide separation of a number of solutions in a single microfluidic device. When the column inflows and/or outflows are connected, parallel configurations also provide reduced total fluidic resistance and thus higher flow rates. Also, the columns can be arranged in both series and parallel manner (not shown) to allow separation of a number of analytes from a number of sample fluids on a singe microfluidic device.

X) Methods of Column Fabrication

The column 10 can be fabricated using various polymer tube and chromatographic column processing methods known in the art. In an exemplary embodiment of a fabrication method, a section of tube 40 is inserted into tube 70t and a first frit 60 is inserted tube 70t so as to abut an end tube 40. Then a first section of tubing 80 (e.g., tube 30) is also inserted into tube 70t so as to abut the opposite face of frit 60 to that abutting tube 40. A slight of amount of heat can be applied at this point to the section of tubing 70t around frit 60 to shrink the tubing around the frit to hold it in place. Then a desired volume of packing 41 can be inserted either dry or as a slurried suspension. Then a second frit is inserted into tube 70t so as to contact the unconstrained end of the packing. Then a section of tube 80 (e.g., tube 50) is inserted so to abut the face of the second frit. Heat is then applied to shrink tubing 70t to apply a compressive force so as fluidically seal tubes 30, 40 and 50 together as well as hold frits 60 in place in tube 70t. The frits can be held in place within tube 70t both by this compressive force and also by contact with adjacent tubes 40 and 80 which themselves are held in place. Heat can applied using a heat gun or using a small hot air nozzle such as those used in catheter thermal boxes known in the art. The ends of tubing 70t (or those of tubing 30 and 50 extending past tubing 70t) can be cut to a desired length. The finished column 10 can then be integrated to a microchip 10 using one or more methods described herein. Typically, this involves mounting the column on/in a recess in the chip and coupling the ends of the column to one or more fluidic channels 90. This can be accomplished by laying the in flow and outflow tube 81 and 82 of the column into open portions of the channels, or into channel access ports, during chip fabrication and then sealing the tubes in place. However, other integration methods are equally applicable.

In alternative embodiments, a second section of tube 80 (e.g., section 30 or 50) need not be used so that one end of the frit is open and tubing 70t forms the inlet or outlet to the column. In these embodiments, the second frit is held in place by the compressive force from the shrunk tubing 70t. In still other embodiments, only one frit can be used (which will typically be at the outlet end of the column) and compressive forces from the heat shrink tubing can be used to hold the packing in place at the inlet end of the column.

XI) Interchangeable Column Embodiments

In particular embodiments, column 10 can be configured to be interchangeable on a microfluidic chip 110 such that a first column can be interchanged with a second column. Interchangeability can be achieved by the use of releasable fittings or laminates that attach the column to the chip and/or that fluidically couple the column to the chip (e.g., to channels 90). Such releasable fittings can include snap or push fittings known in the art. Column inlet and outlet portions 10i and 10o can also be fabricated from more pliable polymer materials such that they can readily attach and detach to fluidic couplings on the chip. In use, embodiments having interchangeable columns allow the chip to be used to perform separation of a first compound in a first mode of operation (e.g. a first experiment) and then be used to perform a separation of a second compound in a second mode of operation (e.g. a second experiment). They also allow for the replacement of fouled or otherwise spent columns without having to replace the entire microfluidic chip.

XII) Embodiments for Use with a Chemical Reaction Device

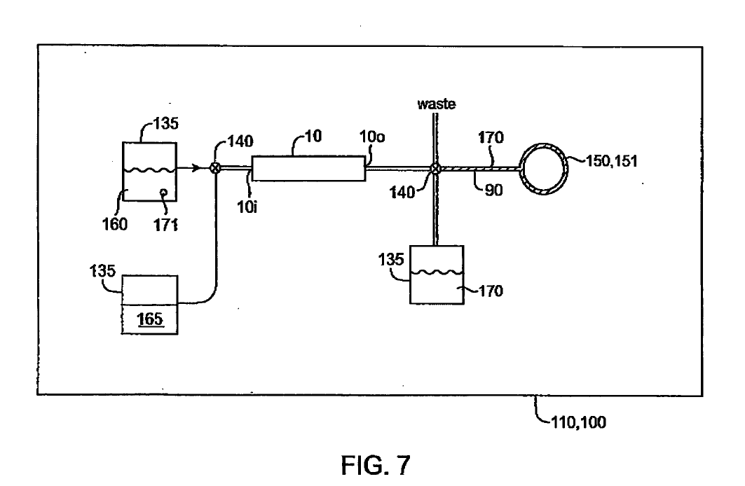

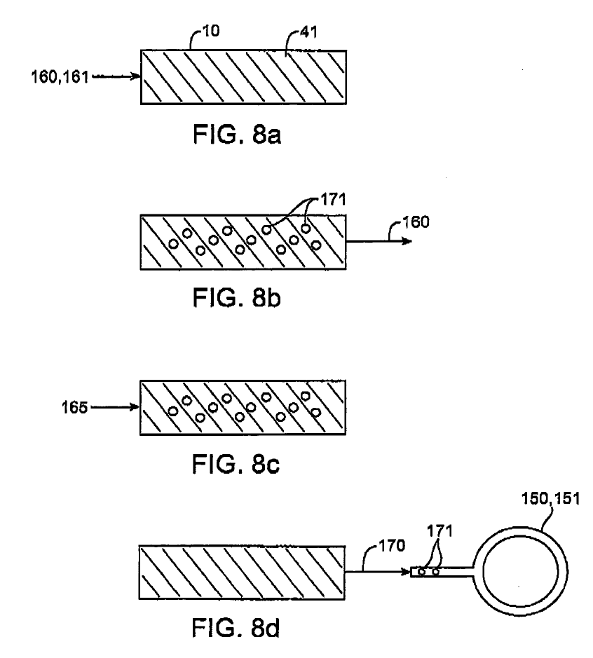

Referring now to FIGS. 7 and 8A-8D, in many embodiments column 10 can be coupled to a component of a chemical reaction device 150 such as a chemical concentration loop or other chemical reaction chamber 151. Typically, chemical reaction device 150 will integrated on chip 110 or other microfluidic system 100. Alternatively, it can be externally coupled to the microfluidic chip or system e.g. via one or more channels 90. Column 10 is coupled to device 150 by one or more channels 90, but can also be coupled by other fluid conduction means. Also, one or more microfluidic valves 140 can be coupled to the inlet 10i and/or outlet of column device 10. The valves can be also used to direct fluid existing and/or entering the column to the chemical reaction device or to another device or location on the chip such as a waste channel, collection reservoir, pump, or detection chamber.

In particular embodiments, column 10 can be used to perform a chromatographic separation on a volume of a sample solution 160 injected into the column to produce a concentrated solution 170 containing one or more compounds 171 used by device 150 (e.g., as reactants). The packing 41 can be selected to bind a particular compound 171, for example, fluoride, for purposes of separation and subsequent concentration of that compound. In many embodiments, an elutent solution 165 is injected into the column to desorb or otherwise release the desired compound from the packing. The driving pressure and/or fluidic resistance through the column can be regulated or otherwise selected to achieve desired output flow for a particular chemical reaction device and/or a particular chemical reaction. Columns having lower amounts of fluidic resistance can be used for reactions that are mass transfer driven where higher flow rates through the column are desirable.

In an exemplary embodiment of a method for using a microfluidic column device to produce a concentrated solution 170 for a chemical reaction device 150, a volume of a sample solution 160 containing a compound 171 is injected into column 10. As the sample volume moves through the column, the compound interacts with the packing 41 so as to adsorb or otherwise bind onto the packing. The remainder of the fluid flows through the column. After the volume of sample solution 160 has flowed through column, an eluting solution 165 is injected into the column, to cause the desorption or release of the compound from the column into the elutent solution to produce concentrated solution 170. The concentrated solution 170 then flows out of the column and into chemical reaction device 150 via channels 90 or other fluid conduction means. One or both of the inflow and the outflow of fluids from the column can be electronically controlled or otherwise automated. This can be accomplished for example, through the use of control valves, metering pumps or other fluid flow control means one more of which can be coupled to a processor. The inflow or outflow can be synchronized or otherwise temporally linked to another event or process used by the chemical reaction device, such as an endpoint in a chemical process or a achievement of a temperature, pressure or flow rate, or rate of change thereof (e.g., a derivative function). For example, in one embodiment, the injection of the elutent solution can be controlled to occur at a selected time after injection of the sample solution or after a selected volume of the sample solution has exited the column. In another embodiment, the flow rate of either solution can be controlled by measuring the concentration of the compound 171 existing the column and/or within reaction device 150. Closed or open loop algorithms including PID algorithms can be used for control. Various embodiments of this and related methods can be used to rapidly separate compounds from various solutions. Various parameters of the process such as flow rate, sequencing, and the like can be selected for the particular sample solution and compound to be separated as well as the particular chemical reaction.

In a particular application, the above method can be used to rapidly concentrate a radioactive fluoride solution (e.g., from 1 ppm to over 100 ppm) which is then used in a chemical reaction chamber to produce a radio-pharmaceutical such as ¹⁸F-fluoro-D-glucose. The microfluidic column can include an anion exchange resin (e.g., a quaternary ammonium compound bound to a polystyrene/divinylbenzene matrix, an example including Source 15Q available from the General Electric Corporation) configured to bind fluoride. A sample volume (e.g. approx 1 ml) of a dilute solution of ¹⁸F-flouride is passed through the column in a fluoride loading step for approximately two minutes. The flow rate through the column can be controlled by a microfluidic metering pump coupled to the column. The existing filtrate solution is diverted to a waste channel by means of a control valve. Following fluoride loading, a volume of K₂CO₃ solution (e.g., 18-20 nl) can be circulated through the column to elute the ¹⁸F-flouride from the column. The concentrated ¹⁸F-flouride solution can then be used introduced into a fluidically coupled loop reactor for synthesis of the ¹⁸F-fluoro-D-glucose or other imaging agent via series of chemical reactions performed in the reactor.

XIII) Embodiments For Use With A Detector And/Or Analytical Instrument

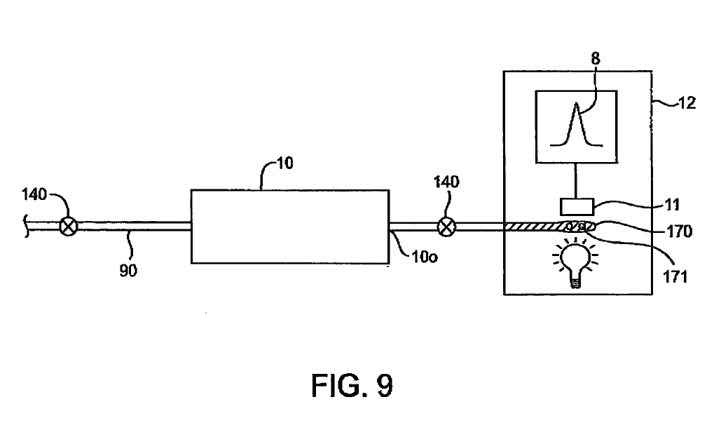

Referring now to FIG. 9, in various embodiments, outlet 10o can be coupled to a detector 11 such as an IR, or UV/VI detector or an analytical instrument 12 such as a gas chromatograph (GC), mass spectrometer (MS) or GC/MS. In particular embodiments, the column can be configured to coupled to a mass spectrometer such as tandem mass spectrometer using an electro-spray ionization (ESI) nozzle (not shown). The nozzle can be coupled directly to outlet 10o, or interconnected via channel 90. Alternatively, the nozzle can actually be formed in a portion of the outlet 10o e.g. on an end portion of tube 50.

In alternative embodiments, all or a portion of column 10 can be made of optically transparent materials. Such embodiments allow for the use of optical sensors to detect the presence of fluid at one or more locations within the column. For example, in one embodiment, an optical sensor could placed at the outlet 10o or inlet 10i of the column to determine when a fluid exists or enters the column. This information can then be used by a processor or other control device to control fluid flow in or out of the column. In related embodiments, optically transparent materials can be chosen to allow portions of the column to function as an optical cuvette for analysis of contained fluid by a spectrophotometer such as an IR or UV spectrophotometer.

### Conclusion

Although the present invention has been described in detail with reference to specific embodiments, those of skill in the art will recognize that modifications and improvements are within the scope and spirit of the invention, as set forth in the claims which follow. All publications and patent documents cited herein are incorporated herein by reference as if each such publication or document was specifically and individually indicated to be incorporated herein by reference.

Further, elements or acts from one embodiment can be readily recombined or substituted with one or more elements or acts from other embodiments to form new embodiments. Moreover, elements that are shown or described as being combined with other elements, can in various embodiments, exist as stand alone elements.

What is claimed is:

1. A device for microfluidic chromatography, the device comprising:
first, second and third capillary tubes, the second tube disposed between the first and third tubes;
a chromatographic packing disposed in the second tube;
a first and second porous support layer disposed on opposite ends of the second tube; and
an external coupling joining the tubes such that the tubes are fluidically sealed;
wherein the device has a fluidic resistance such that a pressure differential across the device of less than about 10 psi produces a flow rate through the joined tubes of at least about 0.5 ml/min for a liquid solution.

2. The device of claim 1, wherein the support layers comprise at least one of a porous membrane or a woven membrane.

3. The device of claim 1, wherein the supports layers have a thickness in a range of 100 to 200 μm.

4. The device of claim 1, wherein the support layers have a pore size in a range of 5 to 20 μm.

5. The device of claim 1, wherein the support layers are disposed in a substantially flat orientation with respect to a longitudinal axis of the device.

6. The device of claim 1, wherein the support layers are held in place by a compressive radial force.

7. The device of claim 1, wherein the solution comprises water, a polar solvent or an organic solvent.

8. The device of claim 1, wherein the device holds between 0.5 to 5 μl of liquid.

9. The device of claim 1, wherein the second tube has a larger diameter than the first or third tubes.

10. The device of claim 9, wherein the diameter of the second part is about five times larger than the diameter of the first or third tubes.

11. The device of claim 1, wherein the second tubes has an internal diameter of about 0.5 mm.

12. The device of claim 1, wherein the first or third tubes has a diameter of about 0.1 mm.

13. The device of claim 1, wherein a residual volume in at least one of the first or third tubes is less than about 500 nl.

14. The device of claim 1, wherein the coupling joins the tubes by a compressive radial force.

15. The device of claim 1, wherein the coupling comprises at least one of a heat shrink material, PTFE, or silastic.

16. The device of claim 1, wherein at least one of the tubes comprises PTFE, silastic or PEEK.

17. The device of claim 1, wherein the packing has a particle size in a range of about of 40 to 100 μm.

18. The device of claim 1, wherein the packing comprises silica particles, chemically coated particles, an ion exchange material, an ion-exchange resin, ion exchange resin coated particles or a metal oxide.

19. The device of claim 1, wherein the packing is configured to separate a first compound from a second compound.

20. The device of claim 19, wherein the first compound is a radionucleotide, a fluorine, a fluoride, a polypeptide or a nucleotide.

21. The device of claim 1, wherein the packing binds a polypeptide, a polynucleotide or a fluoride.

22. The device of claim 1, wherein a pressure differential of less than about 5 psi produces a flow rate of least about 0.5 ml/min.

23. The device of claim 1, wherein the device is configured to be fluidically coupled to at least one of a channel, a pump or a valve.

24. The device of claim 1, wherein the device is configured to be fluidically coupled to a microfluidic chip or microfluidic system.

25. The device of claim 1, wherein the device has a shape configured to fit into a recess on a microfluidic chip.

26. The device of claim 1, wherein the device is configured to be interchangeable with another chromatography device coupled to a microfluidic chip or microfluidic system.

27. The device of claim 1, wherein the device is configured to operate in a substantially horizontal orientation.

28. The device of claim 1, wherein the device is configured to operate at a temperature of up to about 100° C.

29. A microfluidic system for performing chemical analysis, the system comprising:
the chromatography device of claim 1; and
a microfluidic chip fluidically coupled to the chromatography device.

30. A system for performing microfluidic chemical reactions, the system comprising:
the chromatography device of claim 1; and
a microfluidic chemical reaction device fluidically coupled to the chromatography device.

31. A method for performing microfluidic chromatographic separation, the method comprising:
providing a microfluidic chromatography column having a chromatographic packing;
flowing a sample solution containing a compound through the column at a rate of at least 0.5 ml/min using a pressure differential of no more than about 10 psi, wherein at least a portion of compound becomes bound to the packing;
flowing an eluting solution through the column, wherein at least a portion of the bound compound is released from the packing.

32. The method of claim 31, wherein the compound is one of a polypeptide, protein, nucleotide, fluoride, halide, acid or base.

33. The method of claim 31, wherein the sample solution comprises one of an aqueous solution, polar solvent or organic solvent.

34. The method of claim 31, wherein the elutent solution comprises one of an aqueous solution, polar solvent or organic solvent, acid solution or base solution.

35. The method of claim 31, wherein up to about ten mls of sample solution is flowed through the column.

36. The method of claim 31, wherein the pressure differential is no more than about 5 psi.

37. The method of claim 31, wherein the concentration of the compound is at least ten times that of the sample solution.

38. The method of claim 31, wherein elutent solution existing the column is utilized in a microfluidic chemical reactor.

39. The method of claim 31, wherein elutent solution existing the column is utilized in a measurement.

40. The method of claim 31, wherein flow into the column is electronically controlled.

41. The method of claim 31, wherein flow into the column is controlled by a metering pump.

42. A method for fabricating a microfluidic chromatography device, the method comprising:
placing a chromatographic packing material in a first capillary tube;
placing a shrinkable tube over at least a portion of the first capillary tube; and
placing at least one support layer within the shrinkable tube adjacent the first capillary tube;
placing a second capillary tube adjacent the at least one support layer on an opposite side from the first capillary tube; and
shrinking the shrinkable tube over the first capillary tube and at least a portion of second capillary tube, wherein the shrinkable tube holds the support layer in place by a compressive radial force.

43. The method of claim 42, wherein the shrinkable tube is shrunk by the application of heat.

44. The method of claim 42, wherein the at least one support layer has a substantially flat orientation within the shrinkable capillary tube.

45. The method of claim 42, wherein the at least one support layer includes a first and a second support layer, the layers positioned on opposite ends of the packing.

46. The method of claim 45, wherein the second capillary tube is positioned adjacent the first support layer, the method further comprising:
prior to shrinking the shrinkable tubing, placing a third capillary tube adjacent the second support layer on an opposite side from the first capillary tube.

47. The method of claim 42, wherein the microfluidic chromatography device has a fluidic resistance such that a pressure differential across the device of less than about 10 psi produces a flow rate through the device of at least about 0.5 ml/min for a liquid solution.
